(19) United States
(12) Patent Application Publication
(10) Pub. No.: US 2014/0005987 A1
(43) Pub. Date: Jan. 2, 2014

(54) METHOD AND APPARATUS OF OBJECT BASED VIRTUAL FLOOR PLAN CREATION AND REGENERATION

(71) Applicant: Honeywell International Inc., Morristown, NJ (US)

(72) Inventor: Subash Maniyath, Chennal (IN)

(21) Appl. No.: 13/926,315

(22) Filed: Jun. 25, 2013

Related U.S. Application Data
(60) Provisional application No. 61/664,930, filed on Jun. 27, 2012.

(51) Int. Cl. G06F 17/50

(52) U.S. Cl. CPC G06F 17/5004
USPC 703/1

(57) ABSTRACT

Systems and methods of object based virtual floor plan creation and regeneration are provided. Some methods can include storing coordinate data of a floor plan map of a monitored region in a memory device, detecting an alarm event in the monitored region, and transmitting the coordinate data, where the coordinate data is sufficient for dynamically regenerating an image of the floor plan map of the monitored region. Some methods can include receiving coordinate data of a floor plan map of a monitored region and using the coordinate data to dynamically regenerate an image of the floor plan map of the monitored region.

### CROSS-REFERENCE TO RELATED APPLICATIONS

This application claims priority to U.S. Provisional Patent Application No. 61/664,930 filed Jun. 27, 2012 and titled “Method and Apparatus of Object Based Virtual Floor Plan Creation and Regeneration”. U.S. application Ser. No. 61/664,930 is hereby incorporated by reference.

### FIELD

The present invention relates generally to alarm reporting. More particularly, the present invention relates to a method and apparatus of object based virtual floor plan creation and regeneration.

### BACKGROUND

In known systems, when a fire, carbon monoxide, or burglary alarm is reported, the exact location of the alarm is often not clear to operators at an alarm receiving station or local monitoring station. That is, known systems and methods often do not provide the exact and/or precise location of the alarm in a monitored region. However, such location information would be extremely helpful for first responders, such as firemen and policemen, when planning and executing actions to respond to the alarm.

In view of the above, there is a continuing, ongoing need for improved alarm reporting.

### BRIEF DESCRIPTION OF THE DRAWINGS

FIG. 1 is a flow diagram of a method in accordance with disclosed embodiments;

FIG. 2 is a block diagram of a system for executing the method of FIG. 1 and others in accordance with disclosed embodiments;

FIG. 3 is a block diagram of a system for executing the method of FIG. 1 and others in accordance with disclosed embodiments; and

FIG. 4 is a plan view of an exemplary floor plan map with alarms and corresponding coordinate data in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include systems and methods of alarm reporting that include object based virtual floor plan creation and regeneration. For example, when an alarm event occurs in a monitored region, systems and methods disclosed herein can store and transmit coordinate data to a monitoring station to dynamically regenerate an image, such as a floor plan map. That is, the transmitted coordinate data can be converted to a floor plan map image. In some embodiments, the transmitted data can include data, such as mathematical objects and zone coordinates, sufficient to dynamically generate a floor plan map of the monitored region with the location of an alarm event identified thereon.

In some embodiments, systems and methods disclosed herein can store the transmitted data on a memory device associated with the monitoring station, and in some embodiments, systems and methods disclosed herein can download the transmitted data to a PDA, personal computer, portable memory device, and the like.

According to disclosed embodiments, systems and methods need not transmit and store large image files, such as jpeg, bmp, tiff, or dfx files, which can require large memory space and bandwidth. Instead, systems and methods disclosed herein need only transmit and store coordinate data, which, upon receipt, can be used to dynamically regenerate and plot an image. Accordingly, systems and methods disclosed herein can use less memory space and bandwidth.

It is to be understood that the systems and methods disclosed herein are not limited to alarm reporting. Instead, systems and methods disclosed herein can also be employed in safety and/or security applications, such as aircraft monitoring for faults, building controls, industrial process monitoring and controls, fire security, and the like.

According to some embodiments, systems and methods disclosed herein can formulate and/or convert a floor plan map of a monitored region, including the metadata of the floor plan map, into coordinate data that can be used to regenerate and/or reconstruct the floor plan map. For example, the floor plan map and the coordinate data can provide information, including location information, about doors, window, staircases, zones, sensors, devices, access, peripherals, and the like in the monitored region.

In some embodiments, the coordinate data can include two-dimensional and/or three-dimensional based coordinate data that can be used to regenerate and/or reconstruct the floor plan map in a two-dimensional and/or three-dimensional space, respectively. Accordingly, in some embodiments, the floor plan map disclosed herein can be stored as coordinate data and not as an image file.

Systems and methods disclosed herein can also identify sensors in the monitored region and identify the location of the identified sensors with sensor location coordinate data. For example, in some embodiments, the sensor location coordinate data can be used to regenerate and/or reconstruct the location of identified sensors on the regenerated and/or reconstructed floor plan map. In accordance with disclosed embodiments, the identified location of sensors in the monitored region can correspond to an exact or precise location of the sensors and not simply to zones or areas in which the sensors are located.

When an alarm event occurs, systems and methods disclosed herein can transmit the coordinate data and/or the sensor location coordinate data to a monitoring station for dynamic regeneration of an image of the floor plan map. Systems and methods disclosed herein can improve responsiveness to the occurrence of alarm events in the monitored region by also transmitting alarm event coordinate data to the monitoring station for displaying the location of an active alarm event on the regenerated image of the floor plan map. In some embodiments, the monitoring station can transmit a request to solicit the transmission of the coordinate data, sensor location coordinate data, and/or alarm event coordinate data when an alarm event occurs.

Upon receipt of the transmitted coordinate data, sensor location coordinate data, and/or alarm event coordinate data, the monitoring station and/or systems and methods disclosed herein can plot the received data to dynamically create and/or regenerate the image of the floor plan map with, when applicable, the precise location of the alarm event on the floor plan map.

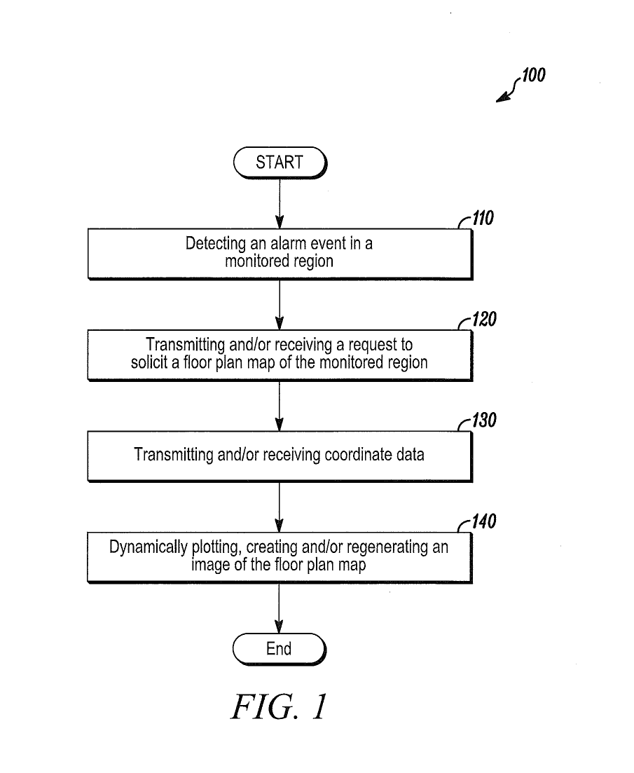

FIG. 1 is a flow diagram of a method 100 in accordance with disclosed embodiments. As seen in FIG. 1, the method 100 can include detecting an alarm event in a monitored region as in 110. Then, the method 100 can include transmitting and/or receiving a request to solicit a floor plan map of the monitored region as in 120.

The method 100 can also include transmitting and/or receiving coordinate data as in 130. For example, in some embodiments, the coordinate data can include sensor location coordinate data and/or alarm event coordinate data. The coordinate data can represent the floor plan map of the monitored region as well as the location of any sensors and/or alarm events in the monitored region.

After transmitting and/or receiving the coordinate data as in 130, the method 100 can include dynamically plotting, creating, and/or regenerating an image of the floor plan map as in 140. For example, the method 100 can use the coordinate data, including the sensor location coordinate data and alarm event coordinate data, to plot, create, and/or regenerate the image of the floor plan map. In some embodiments, the plotted, created, and/or regenerated image of the floor plan map can include and display thereon the exact or precise locations of sensors and/or alarm events in the monitored region.

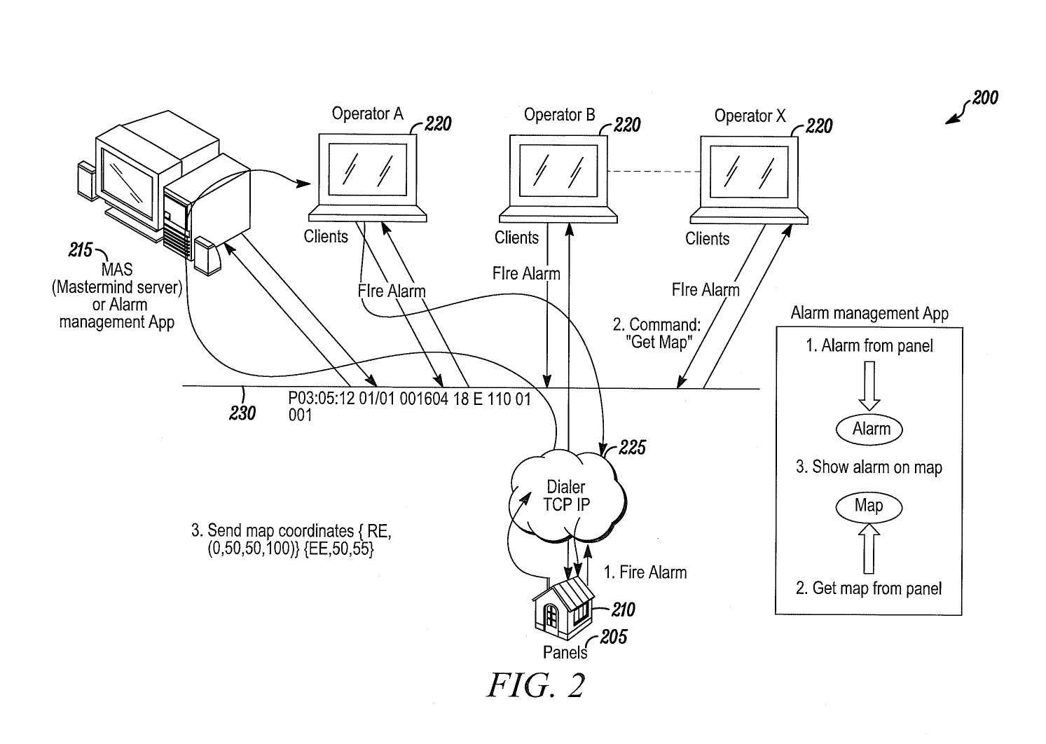

FIG. 2 is a block diagram of a system 200 for executing the method 100 of FIG. 1 and others in accordance with disclosed embodiments. As seen in FIG. 2, the system 200 can include one or more alarm panels 205 located in a monitored region 210, for example, a home. The system 200 can also include a plurality of monitoring stations 220 and a server 215 or other hardware device for storing and executing alarm management software. For example, in some embodiments, each of the plurality of monitoring stations 220 can include a personal computer and/or a viewing screen for displaying a regenerated image of a floor plan map to an operator.

As seen in FIG. 2, each of the alarm panels 205, server 215, and monitoring stations 220 can communication in a bidirectional manner via a LAN/WAN 225 supporting TCP/IP or another suitable protocol as would be known by those of skill in the art. In some embodiments, as least the server 215 and the monitoring stations 220 can communicate via a bus 230.

In some embodiments, one or more of the alarm panels 205 in the monitored region 210 can detect an alarm event and transmit a notification of the alarm event to the server 215 and/or to one or more of the monitoring stations 220. Then, one or more of the monitoring stations 220 can transmit a request to receive a floor plan map of the monitored region 210.

In some embodiments, responsive to the request from the monitoring station 220, the one or more alarm panels 205 can transmit coordinate data stored therein or thereon to the server 215 and/or to the one or more monitoring stations 220. In some embodiments, responsive to the request from the monitoring station 220, the server 215 can transmit the coordinate data stored therein or thereon to the one or more monitoring stations 220. Then, the one or more monitoring stations 220 can use the received coordinate data to dynamically plot, create, and/or regenerate an image of the floor plan map, including the exact or precise location of the detected alarm event in the monitored region 210. The one or more monitoring stations 220 can also display the plotted, created, and/or regenerated image on a viewing screen at the monitoring station 220.

Accordingly, as seen in FIG. 2, the system 200 can receive an alarm notification from an alarm panel 205 in a monitored region 210, can receive coordinate data for a floor plan map of the monitored region 210 from the alarm panel 205 and/or from a server 215, and can use the coordinate data to dynamically plot, create, and/or regenerate and display an image of the floor plan map that includes the precise location of the alarm event in the monitored region 210.

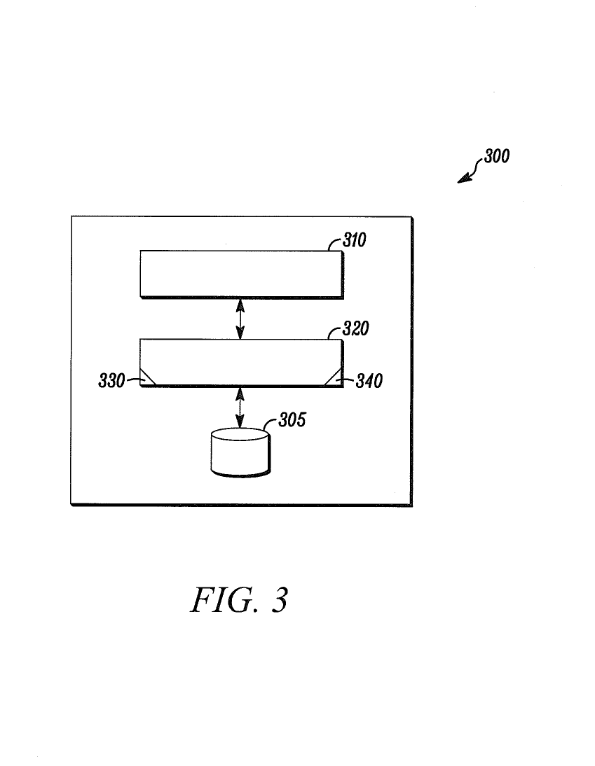

FIG. 3 is a block diagram of a system 300 for executing the method 100 of FIG. 1 and others in accordance with disclosed embodiments. In some embodiments, the system 300 shown in FIG. 3 can include the alarm panel 205, the server 215, and/or the monitoring station 220 shown in FIG. 2.

For example, the system 300 can include a memory device 305, a user interface device 310, control circuitry 320, one or more programmable processors 330, and executable control software 340 stored on a transitory or non-transitory computer readable medium, including, but not limited to, computer memory, RAM, optical storage media, magnetic storage media, flash memory, and the like. In some embodiments, the executable control software 340 can implement some or all of the steps of the method 100 shown in FIG. 1 as well as others disclosed herein.

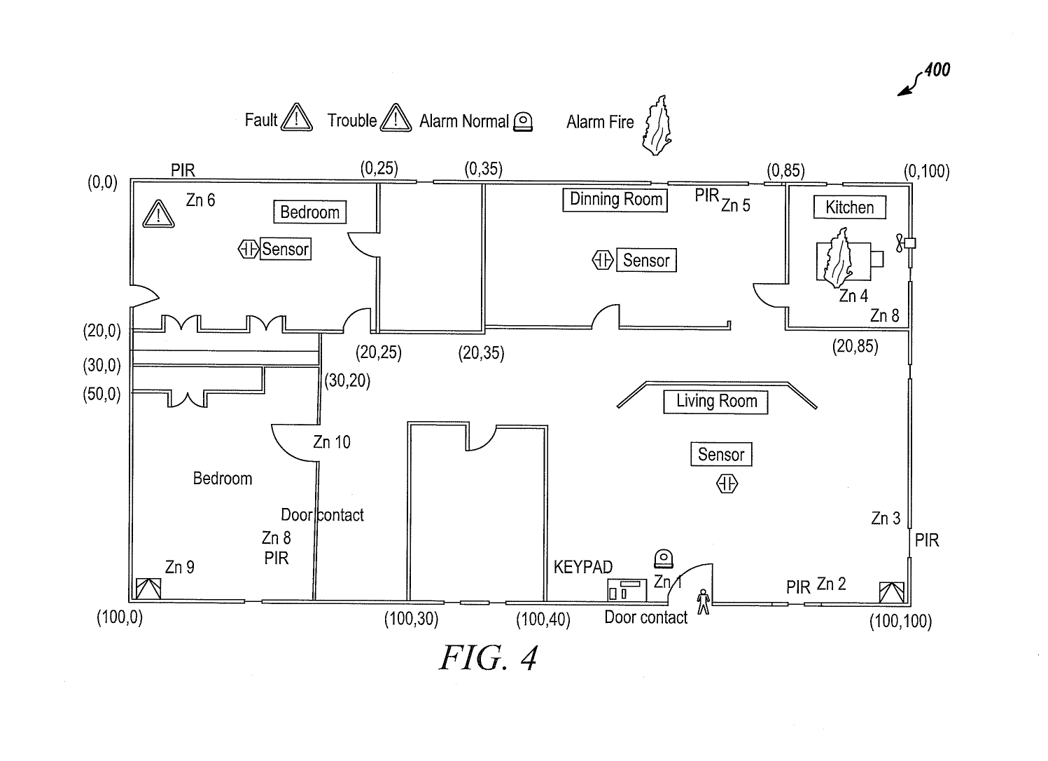

FIG. 4 is a plan view of an exemplary floor plan map 400 with alarms and corresponding coordinate data in accordance with disclosed embodiments. As seen in FIG. 4, the floor plan map 400 can be mapped with coordinate data to describe the layout of the floor plan, the location of rooms, doors, and the like therein, the location of sensors therein, and the location of alarms, including detected alarm events, therein. Then, systems and methods disclosed herein can use the coordinate data to plot, create, and/or regenerate the floor plan map 400 shown in FIG. 4.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the sprit and scope of the invention.

What is claimed is:

1. A method comprising:
receiving coordinate data of a floor plan map of a monitored region; and
using the coordinate data to dynamically regenerate an image of the floor plan map of the monitored region.

2. The method of claim 1 further comprising:
transmitting a request for the coordinate data; and
responsive to the request, receiving the coordinate data.

3. The method of claim 2 further comprising:
receiving a notification of an alarm event in the monitored region; and
responsive to the received notification of the alarm event, transmitting the request for the coordinate data.

4. The method of claim 1 wherein receiving the coordinate data includes receiving the coordinate data from an alarm panel or a server associated with the monitored region.

5. The method of claim 1 wherein receiving the coordinate data includes receiving coordinate data corresponding to a location of an alarm event in the monitored region.

6. The method of claim 1 further comprising displaying the image of the floor plan map on a viewing screen.

7. The method of claim 6 further comprising displaying a location of an active alarm event on the image of the floor plan map.

8. A method comprising:
storing coordinate data of a floor plan map of a monitored region in a memory device;
detecting an alarm event in the monitored region; and
detecting an alarm event in the monitored region; and
transmitting the coordinate data,
wherein the coordinate data is sufficient for dynamically regenerating an image of the floor plan map of the monitored region.

9. The method of claim 8 wherein detecting the alarm event in the monitored region includes transmitting a notification of the alarm event.

10. The method of claim 8 further comprising:
receiving a request for the coordinate data; and
responsive to the request, transmitting the coordinate data.

11. The method of claim 8 wherein transmitting the coordinate data includes transmitting the coordinate data to a server or a monitoring station associated with the monitored region.

12. The method of claim 8 wherein the coordinate data includes coordinate data corresponding to a location of the alarm event in the monitored region.

13. A system comprising:
at least one alarm panel in a monitored region; and
at least one monitoring station associated with the monitored region,
wherein the alarm panel stores coordinate data of a floor plan map of the monitored region in a memory device,
wherein the alarm panel transmits the coordinate data to the monitoring station, and
wherein, upon receiving the coordinate data from the alarm panel, the monitoring station uses the coordinate data to dynamically regenerate an image of the floor plan map of the monitored region.

15. The system of claim 14 wherein, upon receiving the notification of the alarm event from the alarm panel, the monitoring station transmits a request for the coordinate data to the alarm panel.

16. The system of claim 15 wherein the alarm panel transmits the coordinate data to the monitoring station responsive to the request for the coordinate data from the monitoring station.

17. The system of claim 13 wherein bidirectional communication between the alarm panel and the monitoring station is via a server.

18. The system of claim 13 wherein at least one of the alarm panel and the monitoring station includes a programmable processor and executable control software stored on a non-transitory computer readable medium for storing the coordinate data, transmitting the coordinate data, and using the coordinate data to regenerate the image of the floor plan map.

19. The system of claim 13 wherein the coordinate data includes coordinate data corresponding to a location of an alarm event in the monitored region, and wherein the monitoring station includes a representation of the location of the alarm event on the dynamically regenerated image of the floor plan map.

20. The system of claim 19 where the monitoring station displays the dynamically generated image of the floor plan map on a viewing screen.
